(19) United States
(12) Patent Application Publication
(10) Pub. No.: US 2024/0345583 A1
(43) Pub. Date: Oct. 17, 2024

(54) CONTROL SYSTEM FOR CONTROLLING TRANSFER OF MATERIAL FROM A TRANSFER VEHICLE TO A HAULAGE VEHICLE

(71) Applicant: Deere & Company, Moline, IL (US)

(72) Inventors: Rasika H. Wagh, Satara (IN); Mahesh S. Bothe, Kopargaon (IN); Vamshi Sai Ramakrishna Reddy Kotha, HYDERABAD (IN); William J. Vande Haar, JANESVILLE, IA (US)

(21) Appl. No.: 18/495,225

(22) Filed: Oct. 26, 2023

Related U.S. Application Data
(60) Provisional application No. 63/513,105, filed on Jul. 11, 2023.
(60) Provisional application No. 63/495,912, filed on Apr. 13, 2023.

(51) Int. Cl. G05D 1/02; A01D 43/08

(52) U.S. Cl. CPC G05D 1/027; A01D 43/087; A01D 41/1275

(57) ABSTRACT

A detector on a material transfer vehicle detects a haulage vehicle. A localization processor locates a receiving area of the haulage vehicle relative to the material transfer vehicle. A control signal is generated to control a position of the material transfer vehicle so that a material conveyance subsystem is positioned to convey material from the material transfer vehicle to the haulage vehicle.

### CROSS-REFERENCE TO RELATED APPLICATION

The present application is based on and claims the benefit of U.S. provisional patent application Ser. No. 63/513,105, filed Jul. 11, 2023, and U.S. provisional patent application Ser. No. 63/495,912 filed Apr. 13, 2023, the content of which is hereby incorporated by reference in its entirety.

### FIELD OF THE DESCRIPTION

The present description relates to transferring material. More specifically, the present description relates to transferring harvested material from a transfer vehicle to a haulage vehicle.

### BACKGROUND

There is a wide variety of different types of agricultural systems. Some systems include a harvester that harvests material from a field and a transfer vehicle (such as a grain cart) that transfers the harvested material from the harvester to a haulage vehicle. The transfer vehicle is loaded with material from the harvester. The transfer vehicle then transfers the material from itself to a haulage vehicle. The haulage vehicle removes the material from the operation site (e.g., from the field). The haulage vehicle is often a semi-trailer that is pulled by a semi-tractor.

In many harvesting operations, it is common for a harvester to be working in a field or other harvesting operation site. The transfer vehicle often approaches the harvester when the harvester is nearing its capacity of harvested material, and the harvester unloads the harvested material into the transfer vehicle.

The unloading operation can sometimes take place while the harvester is operating so that the transfer vehicle runs alongside, or behind, the harvester as the harvester is unloading material into the transfer vehicle. The harvester simultaneously loads harvested material into the material transfer vehicle. Once the material transfer vehicle is full, the material transfer vehicle often travels to a material transfer site to transfer the material into the haulage vehicle. For instance, it is not uncommon for a semi-trailer to pull into a field or onto the shoulder of a road adjacent a harvesting operation site (such as a field or near a group of fields). The transfer vehicle then pulls up adjacent the semi-trailer and unloads material from the transfer vehicle to the haulage vehicle.

As an example, where the transfer vehicle is a tractor-pulled grain cart, and where the haulage vehicle is a semi-trailer, then the tractor positions itself so that the cart is adjacent the semi-trailer. A spout (with an auger or another conveyance subsystem) is then positioned so that the conveyance subsystem can transfer material from the cart to the semi-trailer through the spout. The auger or other conveyance subsystem is then actuated to transfer the material from the grain cart to the semi-trailer to unload the grain cart. Once unloaded, the grain cart is then free to travel back to the harvester to receive more material from the harvester.

The discussion above is merely provided for general background information and is not intended to be used as an aid in determining the scope of the claimed subject matter.

### SUMMARY

A detector on a material transfer vehicle detects a haulage vehicle. A localization processor locates a receiving area of the haulage vehicle relative to the material transfer vehicle. A control signal is generated to control a position of the material transfer vehicle so that a material conveyance subsystem is positioned to convey material from the material transfer vehicle to the haulage vehicle.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a pictorial illustration of a material transfer vehicle in a first position relative to a haulage vehicle.

FIG. 2 is a pictorial illustration showing a material transfer vehicle in a second position relative to a haulage vehicle.

FIG. 3 is a pictorial illustration showing a material transfer vehicle in yet another position with respect to a haulage vehicle.

FIG. 4 is a pictorial illustration of a material transfer vehicle with an optical sensor deployed on a grain cart.

FIG. 5 is a pictorial illustration of a material transfer vehicle and a haulage vehicle with an optical sensor deployed on a spout of the material transfer vehicle.

FIG. 6 is a block diagram showing one example of an agricultural system.

FIG. 7 is a flow diagram illustrating one example of the operation of the material transfer control system.

FIG. 8 is a flow diagram showing one example of the operation of the material transfer control system, in more detail.

FIG. 9 is a block diagram showing one example of an agricultural system deployed in a remote server environment.

FIGS. 10-12 show examples of mobile devices that can be used in the systems and machines illustrated in other FIGS.

FIG. 13 is a block diagram showing one example of a computing environment that can be used in the systems and machines shown in other FIGS.

### DETAILED DESCRIPTION

As discussed above, it is common during a harvesting operation for a material transfer vehicle (such as a tractor pulling a grain cart) to transfer material from a harvester that is harvesting in a field to a haulage vehicle which hauls the harvested material away from the field or other harvesting operation site (e.g., the harvesting operation site may include multiple different fields in close proximity with one another). The operator of the tractor must align the grain cart with the haulage vehicle (which is often a semi-trailer or a cargo truck) correctly and unload the grain without any spillage. This can be a very tedious task and can also be very difficult and error prone. The operator must normally, at the same time, control the position of the grain cart relative to the semi-trailer or cargo truck, as well as the position of the spout (and flap where a flap is used) to control the landing point of the harvested material within the haulage vehicle. These things must often all be controlled simultaneously in order to successfully unload the harvested material into the haulage vehicle. Similarly, the operator must normally monitor the level of material in the haulage vehicle to obtain an even fill of material in the haulage vehicle.

The present description thus describes a system which includes a haulage vehicle sensor (such as a stereo camera) on the transfer vehicle. As the transfer vehicle approaches the haulage vehicle, the sensor captures an image of at least a portion of the haulage vehicle and using image processing (and/or known dimensions of the haulage vehicle) the edges of the receiving area of the haulage vehicle can be identified and localized to the coordinate system of the material transfer vehicle. The material transfer vehicle is then automatically controlled to move into a transfer position relative to the haulage vehicle and begin transferring material into the haulage vehicle. A fill level detector detects the fill level of material within the haulage vehicle and controls the propulsion and steering subsystems on the material transfer vehicle to transfer material into the haulage vehicle according to a transfer strategy (such as a front-to-back strategy or a back-to-front strategy, etc.). The present description thus describes a system which automatically controls the position of the spout and grain cart relative to the haulage vehicle to automatically execute a transfer operation. By automatically, it is meant, in one example, that the operation or function is performed without further human involvement, except, perhaps to initiate or authorize the function or operation.

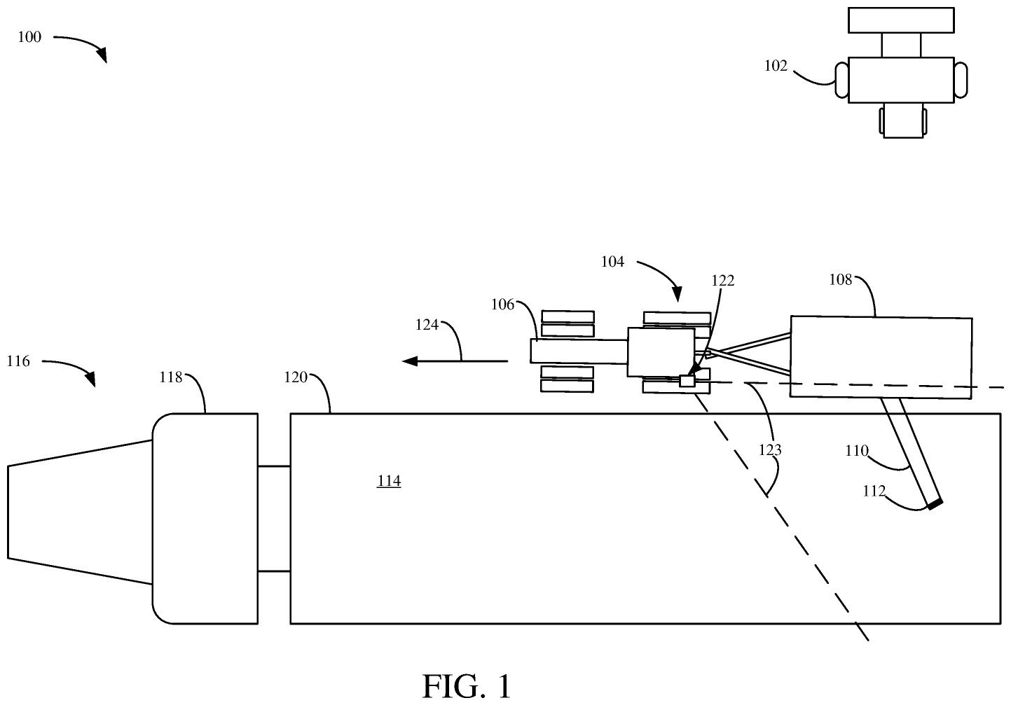

FIG. 1 is a pictorial illustration of one example of an agricultural system 100 in which a harvester 102 (e.g., a combine harvester) is harvesting material from a field. A material transfer vehicle (or transfer vehicle) 104 includes a propulsion vehicle (or tractor) 106 that is providing propulsion to (e.g., towing) a grain cart 108. The grain cart 108 illustratively has a spout 110 that includes an auger that transfers material from the grain cart 108 up through spout 110 and out an outlet end 112 of spout 110 into a receiving area 114 of a haulage vehicle 116. Spout 110 may have a flap mounted on the distal end or the outlet end 112 to control the trajectory of material exiting spout 110. In the example shown in FIG. 1, haulage vehicle 116 includes a semi-truck that has a semi-tractor 118 coupled to a semi-trailer 120.

In operation, grain cart 108 of transfer vehicle 104 may receive harvested material from harvester 102 while harvester 102 is harvesting in the field, or while harvester 102 is stationary. When grain cart 108 is filled, (or when the harvester 102 is unloaded) transfer vehicle 104 moves into position adjacent haulage vehicle 116 so that the spout 110 can be positioned over the receiving area 114 of haulage vehicle 116 in order to transfer material from grain cart 108 to receiving area 114 of haulage vehicle 116. In one example, transfer vehicle 104 has a haulage vehicle sensor 122 which may be a stereo camera that has a field of view indicated by dashed lines 123 or another sensor that senses haulage vehicle 116. For instance, sensor 122 can be a stereo camera which captures one or more images of hauling vehicle 116, along with an image processing system that processes the images to identify parts of haulage vehicle 116 (e.g., the edges or bounds of receiving area 114). The part of haulage vehicle 116 that is identified in the images captured by sensor 122 can then be localized to a coordinate system corresponding to material transfer vehicle 104 so that the location of receiving area 114 (and the edges or bounds of receiving area 114) can be identified relative to the location of the outlet end 112 of spout 110. Based upon the location of outlet end 112 of spout 110 relative to receiving area 114, a control system on material transfer vehicle 104 can then control the steering and propulsion subsystems of tractor 106 in order to automatically move material transfer vehicle 104 into a desired location relative to haulage vehicle so that the harvested material in grain cart 108 can be unloaded into receiving area 114 of haulage vehicle 116.

Also, in one example, the control system includes a fill level detection system that detects the fill level of material in receiving area 114 at the landing point where material is landing in receiving area 114, as it is unloaded through spout 110. When the material level is within a threshold value of a desired fill level, then the control system can generate control signals to automatically move material transfer vehicle 104, such as in the direction indicated by arrow 124. In one example, material transfer vehicle 104 is moved so that the landing point of material exiting spout 110 is at a new location within receiving area 114 of haulage vehicle 116 so that the receiving area 114 of haulage vehicle 116 can be evenly filled with harvested material.

Also, in one example, where receiving area 114 is already partially filled when material transfer vehicle 104 approaches haulage vehicle 116, then the control system processes the images captured by sensor 122 to identify an initial landing point within receiving area 114 that is not already full. The control system can control material transfer vehicle 104 to move to a location such that the outlet end 112 of spout 110 is positioned to transfer material to the initial landing point.

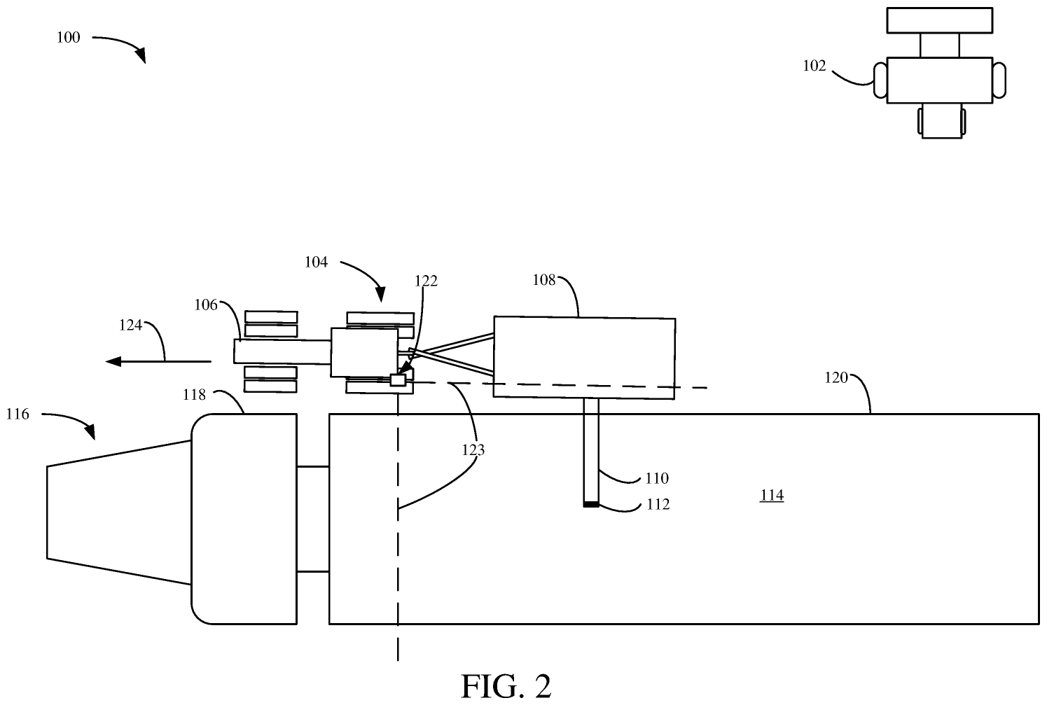

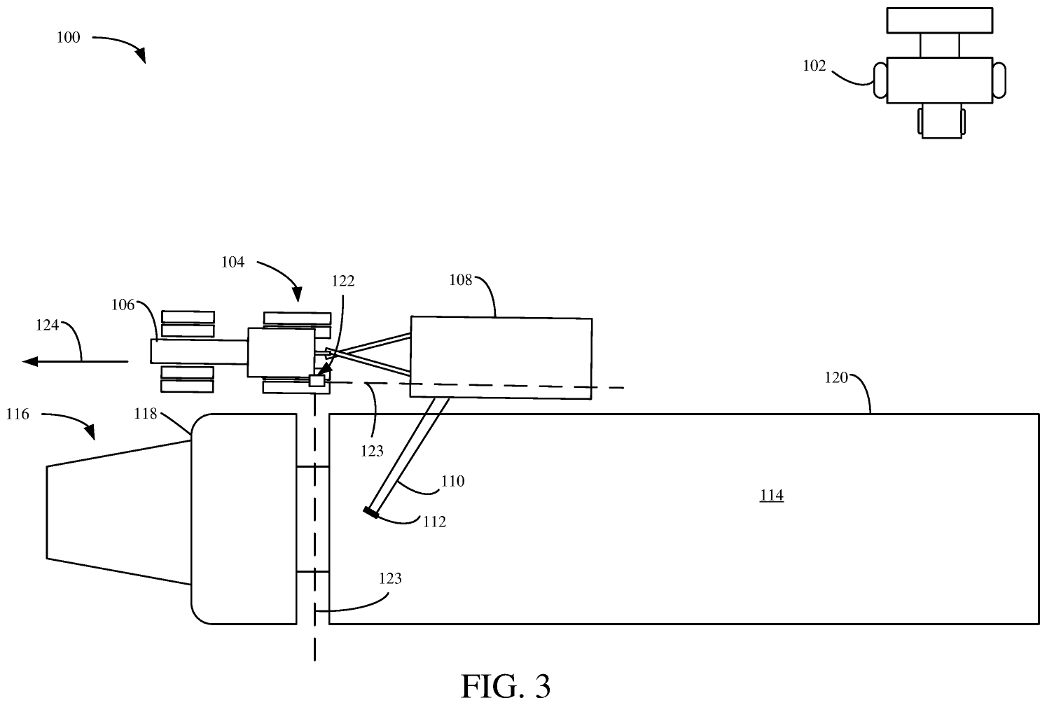

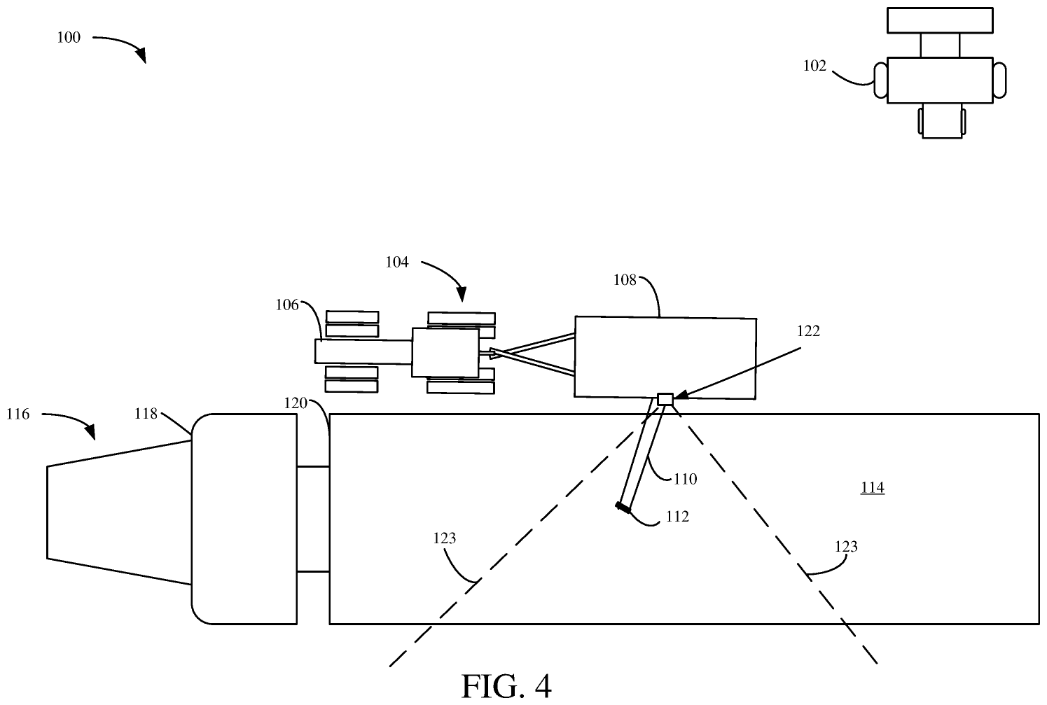

FIG. 2 is similar to FIG. 1, and similar items are similarly numbered. However, it can be seen in FIG. 2 that material transfer vehicle 104 has moved to a new location relative to haulage vehicle 116 so that the landing point of material from grain cart 108 is now in a more central location within receiving area 114 than it was in FIG. 1. FIG. 3 is similar to FIG. 4, and similar items are similarly numbered. However, it can be seen that in FIG. 3 that material transfer vehicle 104 has been moved further forward in the direction indicated by arrow 124 so that the landing point of material exiting spout 110 is now at a forward location in receiving area 114. It will be noted, of course, that material transfer vehicle 104 can also approach haulage vehicle 116 in the opposite direction to that shown in FIGS. 1-3 or on the opposite side of receiving area 114 so that material transfer vehicle 104 can begin loading haulage vehicle 116 at a forward end of receiving area 114, or in a central area of receiving area 114, or at a different location. The positions of transfer vehicle 104 shown in FIGS. 1-3 are shown for the sake of example only.

Also, it will be noted that the control system can identify the forward and rearward edges (or walls), as well as the side edges (or walls), of receiving area 114. In one example, the control system enforces a boundary that is offset inwardly into receiving area 114 from the edges or walls of receiving area 114 so that the landing point of material does not cross the boundary. This can be done in order to reduce the likelihood of accidental spillage of harvested material over the edges or walls of receiving area 114.

FIG. 4 is similar to FIG. 2, and similar items are similarly numbered. However, in FIG. 4 it can be seen that sensor 122 is now mounted on grain cart 108, instead of on tractor 106. In one example, sensor 122 is mounted on an extension arm which raises sensor 122 above the edges or walls of receiving area 114 to a sufficient elevation that the field of view 123 of sensor 122 can capture a portion of receiving area 114 and so that image processing can be used to identify the edges or walls of receiving area 114 proximate the landing point of material exiting spout 110.

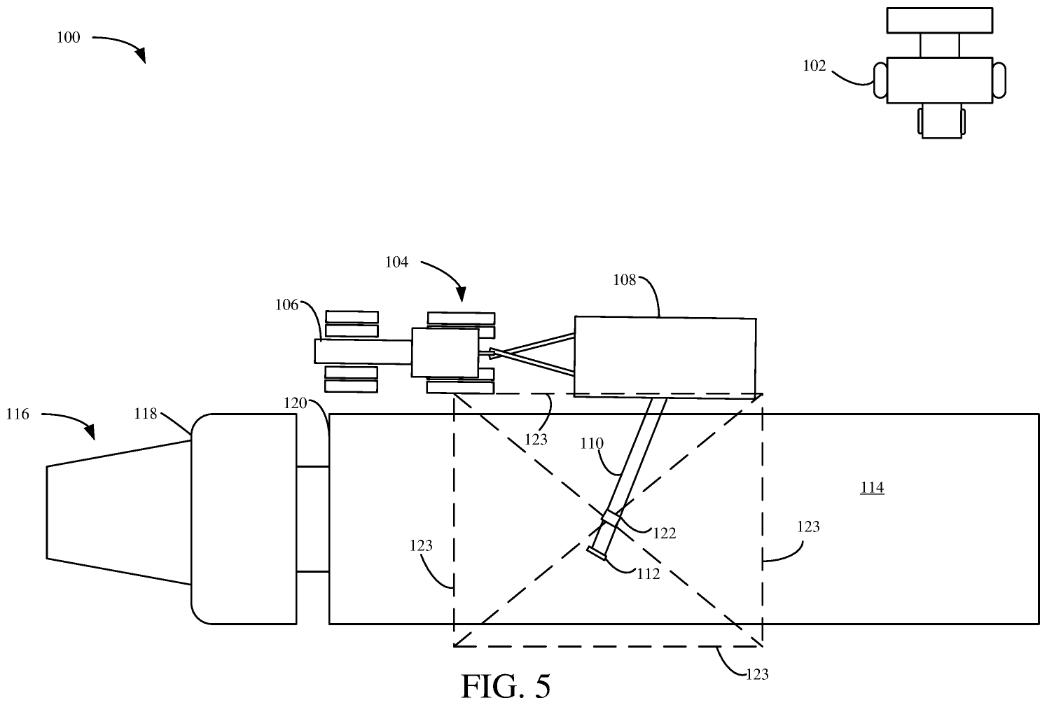

FIG. 5 is similar to FIG. 4 except that FIG. 5 shows that sensor 122 is now mounted on spout 110. Thus, the field of view 123 of sensor 122 is directed more downwardly onto receiving area 114 so that the edges or walls of receiving area 114 proximate the landing point of material exiting spout 110 can be identified in the captured images. It will be noted that sensor 122 can be mounted in other locations as well and those locations shown in FIGS. 1-5 are shown for the sake of example only.

Also, the location and orientation of sensor 122 on transfer vehicle 104 is illustratively known so that the location of the edges or walls of receiving area 114 in the captured images can be localized to (or located relative to) sensor 122 and then to other parts of material transfer vehicle 104 so that material transfer vehicle 104 can be guided into a desired location relative to haulage vehicle 116 to perform the desired material transfer operation.

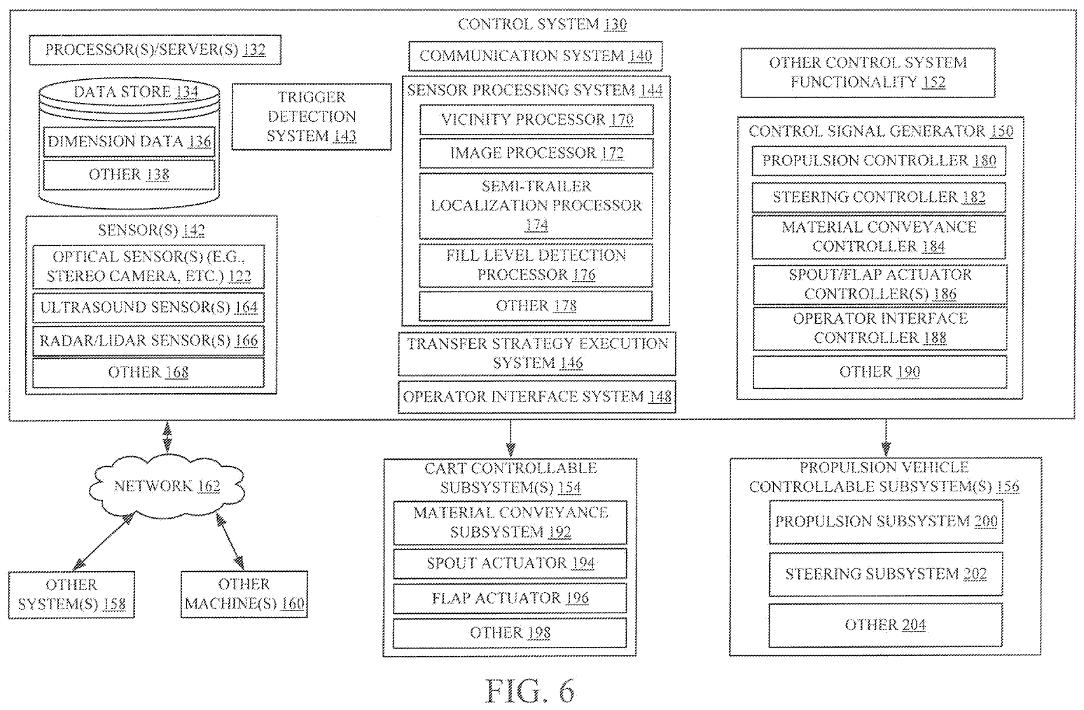

FIG. 6 is a block diagram of one example of a material transfer control system 130 that can be used in the agricultural system 100 shown in FIGS. 1-5. FIG. 6 shows that material transfer control system 130 can be connected to one or more cart controllable subsystems 154 on grain cart 108 and/or to propulsion vehicle controllable subsystems 156 on tractor 106. Material transfer control system 130 can also be coupled to other systems 158 and other machines 160 over a network 162. The other systems 158 can be farm manager systems, vendor systems, systems in other vehicles, etc. Other machines 160 can include harvester 102, other tender vehicles, other haulage or material transfer vehicles, etc. Network 162 can thus include a wide area network, a local area network, a near field communication network, a wifi or Bluetooth network, a cellular communication network, or any of a wide variety of other networks or combinations of networks. Also, while material transfer control system 130 is shown communicating directly with cart controllable subsystems 154 and propulsion vehicle controllable subsystems 156, that communication can also be over network 162 or accomplished in other ways.

It will be noted that the items in material transfer control system 130 can all be located on tractor 106 or on grain cart 108, or the items can be disbursed at different locations or in a remove server environment or other locations accessible by agricultural system 100. In the example shown in FIG. 6, material transfer control system 130 includes one or more processors or servers 132, data store 134 (which can include dimension data 136 and other data 138), communication system 140, sensors 142, trigger detection system 143, sensor processing system 144, transfer strategy execution system 146, operator interface system 148, control signal generator 150, and other control system functionality 152.

Sensors 142 can include one or more optical sensors 122 (such as a stereo camera, etc.), ultrasound sensors 164, RADAR and/or LIDAR sensors 166, and any of a wide variety of other sensors 168. Sensor processing system 144 can include vicinity processor 170, image processor 172, semi-trailer localization processor 174, fill level detection processor 176, and other items 178. Control signal generator 150 can include propulsion controller 180, steering controller 182, material conveyance controller 184, spout/flap actuator controller(s) 186, operator interface controller 188, and other items 190.

Cart controllable subsystems 154 can include a material conveyance subsystem 192 which may include one or more augers or other conveyers, spout actuator 194, flap actuator 196, and/or other subsystems 198. Propulsion vehicle controllable subsystems 156 can include propulsion subsystem 200, steering subsystem 202, and other items 204. Before describing the overall operation of material transfer control system 130 in more detail, a description of some of the items in material transfer control system 130, and their operation, will first be provided.

Trigger detection system 143 detects a trigger criterion indicating that material transfer control system 130 is to take over automated control of material transfer vehicle 104 to transfer material to haulage vehicle 116. The trigger criterion may indicate that material transfer vehicle 104 is approaching, and within a threshold proximity of, haulage vehicle 116. The trigger criterion may be based on an operator input indicating that system 130 should take over automated control, or any of a variety of other criterion.

Dimension data 136 may include the dimensions of haulage vehicle 116, such as the dimensions of receiving area 114, and other dimensions. Thus, by capturing an image of a portion of receiving area 114 and identifying, for example, one edge of receiving area 114, then the location of the opposite edge can also be estimated using the dimension data 136. This is just one example of the dimension data 136 that can be used.

Ultrasound sensors 164 can be used in addition to, or instead or, optical sensors 122. Ultrasound sensors 164 may be used on tractor 106, for instance, to sense the location of haulage vehicle 116 relative to material transfer vehicle 104, etc. RADAR/LIDAR sensors 166 can be used instead of, or in addition to, other sensors. Sensors 166 can also be used to sense the location of haulage vehicle 116 relative to material transfer vehicle 104, or to sense other items.

Communication system 140 is configured to enable communication of the items of material transfer control system 130 with one another, and with subsystems 154 and 156 and also with other items over network 162. Therefore, communication system 140 can include a controller area network (CAN) bus and bus controller, as well as components that are configured to communicate over network 162 and/or directly with subsystems 154 and 156.

Sensor processing system 144 processes the signals received from sensors 142. Vicinity processor 170 can process the sensor signals to identify the locations of haulage vehicle 116 and material transfer vehicle 104 relative to one another to determine whether material transfer vehicle 104 is in the vicinity of haulage vehicle 116 so that automated control of the propulsion and steering subsystems 200, 202 should commence in order to move material transfer vehicle 104 into a position relative to haulage vehicle 116 to begin unloading material. Image processor 172 can process the images captured by optical sensor 122 to identify items within the captured images, such as the edges of receiving area 114, the level of material within receiving area 114, among other things. Semi-trailer localization processor 174 localizes the items identified in the images by image processor 172 to a coordinate system corresponding to material transfer vehicle 104. For instance, by locating the edges of receiving area 114 in a captured image, and by accessing data in data store 134 indicative of the location and orientation of optical sensor 122 on material transfer vehicle 104, the location of those edges can then be located relative to other portions of material transfer vehicle 104, such as relative to the outlet end of 112 of spout 110, relative to the edges of grain cart 108 and tractor 106, etc.

Fill level detection processor 176 detects the level of material in receiving area 114 based upon the captured image or based upon other sensor inputs. The fill level can be detected by generating a point cloud based on items in the captured image and processing the point cloud to identify the height of material at each point in the captured image. The fill level can be detected in other ways as well.

Fill strategy execution system 146 then generates outputs to control signal generator 150 to execute a fill strategy. For instance, fill strategy execution system 146 may be configured or programmed to execute a back-to-front fill strategy. In that case transfer strategy execution system 146 generates outputs to control signal generator 150 so control signal generator 150 generates control signals to automatically move material transfer vehicle 104 to a location so that the landing point of material exiting spout 110 will be at a first location in receiving area 114 (offset from the rear of receiving area 114) that is not yet filled to a desired fill level. Then, based upon the detected fill level, transfer strategy execution system 146 can activate material conveyance subsystem 192 to fill the location to a desired fill height and to then generate outputs to control signal generator 150 so that control signal generator 150 can automatically move material transfer vehicle 104 forward relative to receiving area 114 so that the landing point of material being unloaded from grain cart 108 also moves forward to execute the back-to-front fill strategy. This is just one example of how transfer strategy execution system 146 can work, and other fill strategies can be executed as well.

Operator interface system 148 can include operator interface mechanisms and control systems to convey information to an operator of tractor 106 and to receive inputs from the operator of tractor 106 in order to control material transfer vehicle 104. Thus, the operator interface mechanisms may include a display screen, a touch sensitive display screen, a point and click device or another device that receives operator inputs, a steering wheel, joysticks, levers, pedals, knobs, buttons, linkages, etc. The operator interface system 148 can also include a microphone and speaker where, for instance, speech recognition and speech synthesis are provided. Operator interface system 148 can include other items for providing audio, visual, and haptic output and receiving operator inputs as well. The operator can be a human operator or an automated operator.

Control signal generator 150 generates control signals to control the cart controllable subsystems 154 and propulsion vehicle controllable subsystems 156 to automatically execute a material transfer operation in which material is transferred from grain cart 108 to receiving area 114 of haulage vehicle 116. Propulsion controller 180 can generate control signals to control the propulsion subsystem 200 of tractor 106 in order to move material transfer vehicle 104 to a desired position relative to haulage vehicle 116. Steering controller 182 generates control signals to control steering subsystem 202 in order to control the heading and/or route of tractor 106 and thus of material transfer vehicle 104. Material conveyance controller 184 generates control signals to control material conveyance subsystem 192 (such as augers or other conveyors to begin unloading, and to stop unloading, material from grain cart 108. Spout/flap actuator controller(s) 186 generate control signals to control spout actuator 194 and/or flap actuator 196 to control the trajectory and landing point of material exiting spout 112 within receiving area 114. Operator interface controller 188 generates control signals to control operator interface system 148.

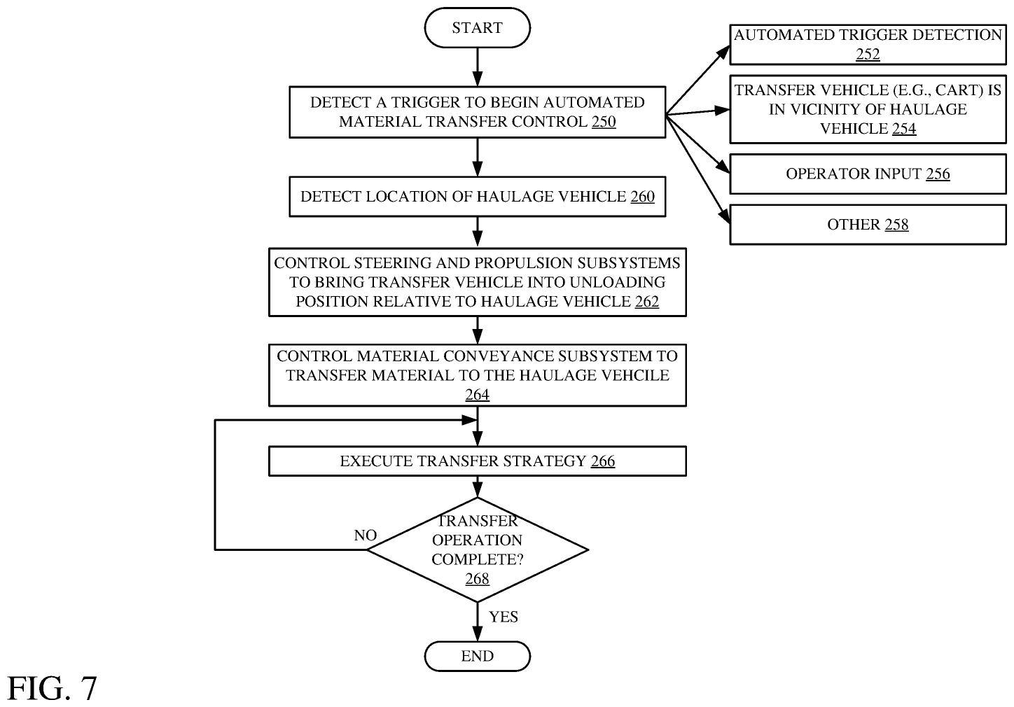

FIG. 7 is a flow diagram illustrating one example of the operation of material transfer control system 130. Trigger detection system 143 first detects a trigger to begin automated material transfer control, as indicated by block 250 in the flow diagram of FIG. 7. System 143 can perform automated trigger detection 252. For instance, when vicinity processor 170 generates an output indicating that the transfer vehicle 104 is within a threshold distance (e.g., in the vicinity of) haulage vehicle 116, this may indicate that material transfer vehicle 104 is approaching haulage vehicle 116 for an unload operation. Detecting a trigger to perform automated material transfer control using the transfer vehicle vicinity relative to the haulage vehicle is indicated by block 254 in the flow diagram of FIG. 7. In another example, trigger detection system 143 detects an operator input 256 as a trigger. For instance, the operator of tractor 106 may observe that vehicle 104 is within a desired proximity of vehicle 116 and provide an input to engage material transfer control system 130 to perform automated material transfer control. In that case, system 130 may take over the propulsion and steering of vehicle 106 as well as the engagement of the material conveyance subsystem 192 on cart 108. Trigger detection system 143 can detect a trigger in other ways as well, as indicated by block 258.

Vicinity processor 170 then detects the location of haulage vehicle 116 based on an input from one of the sensors 142. Detecting the location of haulage vehicle 116, relative to the location of material transfer vehicle 104, is indicated by block 260 in the flow diagram of FIG. 7. For instance, the optical sensor 122 or the ultrasound sensor 164 or the RADAR or LIDAR sensors 166 can generate a signal indicating the direction and distance that haulage vehicle 116 is located relative to material transfer vehicle 104. Based upon the signal from vicinity processor 170, control signal generator 150 generates control signals to control the steering subsystem 202 and propulsion subsystem 200 of material transfer vehicle 104 to bring the material transfer vehicle 104 into an initial unloading position relative to haulage vehicle 116, as indicated by block 262 in the flow diagram of FIG. 7. By way of example, propulsion controller 180 can control propulsion subsystem 200 and steering controller 182 can control steering subsystem 202 using a navigation system or other system to bring the material transfer vehicle 104 alongside haulage vehicle 116.

Once in the initial unloading position, material conveyance controller 184 and spout/flap actuator controller 186 generate control signals to control the material conveyance subsystem 192 and the spout actuator 194 and/or flap actuator 196 to transfer material to the haulage vehicle 116. Transfer strategy execution system 146 generates control signals to execute a fill strategy in which the material in cart 108 is unloaded into receiving area 114 of haulage vehicle 116. Controlling the material conveyance subsystem to transfer material to the haulage vehicle 116 is indicated by block 264 in the flow diagram of FIG. 7 and generating control signals to execute a transfer strategy is indicated by block 266 in the flow diagram of FIG. 7. Until the transfer operation is complete, as determined at block 268, operation reverts back to block 266 where transfer strategy execution system 146 continues to execute the material transfer strategy in transferring material from cart 108 to receiving area 114 on haulage vehicle 116.

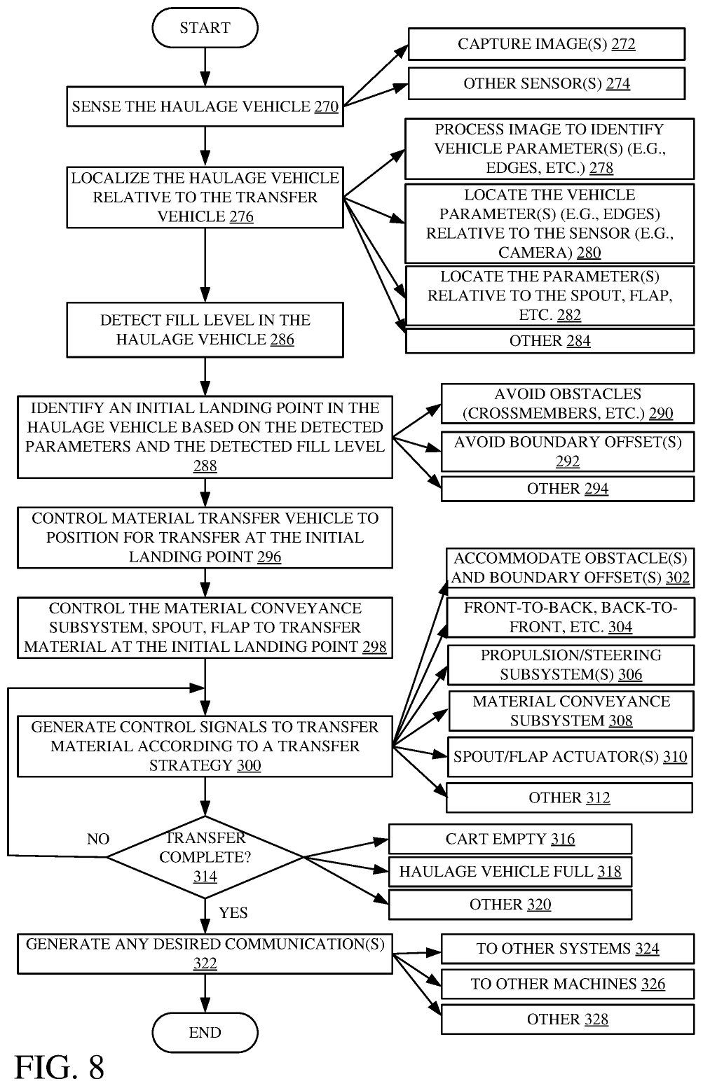

FIG. 8 is a flow diagram illustrating one example of the operation of material transfer control system 130 in more detail. Vicinity processor 170 senses the haulage vehicle 116 based upon a sensor signal from one or more of sensors 142. Sensing the haulage vehicle is indicated by block 270 in the flow diagram of FIG. 8. Sensing the haulage vehicle with an optical sensor 122 based on captured images is indicated by block 272. Sensing the haulage vehicle based upon an input from one or more other sensors 142 is indicated by block 274 in the flow diagram of FIG. 8.

Semi-trailer localization processor 174 then localizes the haulage vehicle 116 relative to the transfer vehicle 104, as indicated by block 276 in the flow diagram of FIG. 8. In one example, for instance, image processor 172 processes images of haulage vehicle 116 to identify vehicle parameters (such as the back edge of receiving area 114, one or more of the side edges of receiving area 114, the front edge of receiving area 114, etc. Processing an image to identify vehicle parameters of haulage vehicle 116 is indicated by block 278 in the flow diagram of FIG. 8. Semi-trailer localization processor 174 then locates the vehicle parameters (identified in the images) relative to the sensor (e.g., relative to the camera 122) as indicated by block 280. For instance, processor 174 may obtain dimension data 136 which identifies the location and orientation of sensor 122 on tractor 126 or on grain cart 108. Processor 174 can also access dimension data 136 which indicates the field of view 123 of optical sensor 122 so that the location (direction and distance) of items identified in images captured by camera 122 can be determined relative to the location of camera 122 on tractor 106 or cart 108. Then, localization processor 174 can obtain dimension data 136 indicating the location of the outlet end 112 of spout 110 (or other portions of vehicle 104) relative to the location of the camera 122. Locating the parameters (e.g., edges of receiving area 114) relative to different portions of material transfer vehicle 104 (e.g., relative to the edges or tires of tractor 106, the edges of cart 108, relative to spout 110, or outlet 112 of spout 110, etc.) is indicated by block 282 in the flow diagram of FIG. 8. Semi-trailer localization processor 174 can localize the haulage vehicle 116 relative to the material transfer vehicle 104 in other ways as well, as indicated by block 284.

Fill level detection processor 176 then detects the fill level of material in the receiving area 114 of haulage vehicle 116, as indicated by block 286 in the flow diagram of FIG. 8. For instance, based upon the field of view 123 of sensor 122, the height of material in receiving area 114 (at least in the area of the field of view 123 of sensor 122) can be determined. Based upon the fill level, fill level detection processor 176 identifies an initial landing point in receiving area 114 where material transfer vehicle 104 is to begin transferring material from cart 108 into receiving area 114 of haulage vehicle 116. In one example, fill level detection processor 176 identifies whether the height of material in receiving area 114 is within a threshold distance of the top edge of receiving area 114. If so, then material transfer vehicle 104 moves forward so that the field of view 123 of camera 122 captures another portion of receiving area 114 and fill level detection processor 176 again determines whether the height of material in material receiving area 114 is within a threshold distance of the top edge of material receiving area 114. This continues until fill level detection processor 176 identifies a location in receiving area 114 that is not filled with material. The identified location is identified as the initial landing point where cart 108 will begin unloading material into material receiving area 114. Identifying the initial landing point is indicated by block 288 in the flow diagram of FIG. 8.

In one example, semi-trailer 120 may have obstacles that extend over material receiving area 114, such as tarp support structures, or other obstacles. In that case, fill level detection processor 176 identifies the initial landing point so that the material will avoid the cross members or other support structures, as indicated by block 290 in the flow diagram of FIG. 8. In another example, there may be inward boundary offsets from the edges or walls of material receiving area 114. Fill level detection processor 176 identifies the landing point so that it does not reside in one of the boundary offset areas. This increases the likelihood that accidental spills of material over the edges of semi-trailer 120 will be avoided. Avoiding the boundary offsets is indicated by block 292 in the flow diagram of FIG. 8. The initial landing point can be identified in other ways as well, as indicated by block 294.

Once the initial landing point is identified, then control signal generator 150 generates control signals to position the material transfer vehicle 104 (and the outlet end 112 of spout 110) in a position to transfer material at the initial landing point. Controlling the position of material transfer vehicle 104 in this way is indicated by block 296 in the flow diagram of FIG. 8.

Transfer strategy execution system 146 then generates outputs to control signal generator 150 so that control signal generator 150 can control the material conveyance subsystem 192, spout actuator 194, and/or flap actuator 196 to begin conveying material from cart 108 to the initial landing point in receiving area 114. Generating control signals to begin transferring material at the initial landing point is indicated by block 298 in the flow diagram of FIG. 8.

Transfer strategy execution system 146 then continues to receive inputs from sensor processing system 144 and/or sensors 142 (and possibly other sources) and provides outputs to control signal generator 150 so that control signal generator 150 generates control signals to transfer material from cart 108 to the receiving area 114 of haulage vehicle 116 according to a desired transfer strategy, as indicated by block 300 in the flow diagram of FIG. 8. In one example, transfer strategy execution system 146 determines when a current landing point is about to be filled to a desired fill level and then identifies a next adjacent landing point in receiving area 114 where material transfer will continue. In doing so, system 146 may accommodate obstacles (such as tarp supports) and boundary offsets so that the next subsequent landing point will be chosen to avoid material being transferred onto obstacles, and so the next subsequent landing point is outside any boundary offset. Accommodating obstacles and boundary offsets is indicated by block 302 in the flow diagram of FIG. 8.

In one example, transfer strategy execution system 146 continues to generate outputs to control signal generator 150 so that a current landing point is filled to a desired fill level and a next adjacent landing point is identified and material transfer vehicle 104 is controlled to move to the next adjacent landing point, and to repeat those operations, until a desired transfer strategy has been executed. The transfer strategy may, for instance, be a front-to-back strategy, a back-to-front strategy, etc. as indicated by block 304 in the flow diagram of FIG. 8. As discussed, propulsion controller 180 and steering controller 182 can generate control signals to control the propulsion subsystem 200 and steering subsystem 202, respectively, on tractor 106 in order to move to the next adjacent landing points identified by the transfer strategy execution system 146. Controlling the propulsion and steering subsystems 200 and 202, respectively, is indicated by block 306 in the flow diagram of FIG. 8. Material conveyance controller 184 controls the material conveyance subsystem 192 and spout/flap actuator controller 186 controls the spout and flap actuators 194 and 196 to control the position of spout 110 and/or a flap on the end of spout 110, as indicated by blocks 308 and 310 in the flow diagram of FIG. 8. Control signals can be generated in other ways to control the material transfer operation, as indicated by block 312.

Until a transfer operation is complete, as determined at block 314, processing reverts to block 300 where transfer strategy execution system 146 continues to generate outputs to control signal generator 150 in order to execute the desired material transfer strategy. Transfer strategy execution system 146 can detect that a transfer operation is complete in a number of different ways. For example, when cart 108 is empty, this may be detected by one of sensors 142 and transfer strategy execution system 146 may determine, in response to cart 108 being empty, that the transfer operation is complete. Detecting a complete transfer operation based on cart 108 being empty is indicated by block 316 in the flow diagram of FIG. 8. In another example, fill level detection processor 176 may detect that the entire material receiving area 114 of haulage vehicle 116 is filled, and this may indicate that the transfer operation is complete. Detecting that the haulage vehicle 116 is full is indicated by block 318 in the flow diagram of FIG. 8. Detecting the completion of the material transfer operation may be done in a wide variety of other ways as well, as indicated by block 320 in the flow diagram of FIG. 8.

When the transfer operation is complete, then control signal generator 150 can control communication system 140 to communicate any desired information to other systems 158, other machines 160, or elsewhere. For instance, the amount of material transferred can be communicated. The location in receiving area 114 where material transfer vehicle 104 completed its transfer operation can be communicated. A wide variety of other information can be communicated as well. Generating any desired communications is indicated by block 322. Generating communications to other systems is indicated by block 324 and generating communications to other machines is indicated by block 326. Communications can be generated in a wide variety of other ways as well, as indicated by block 328.

It can thus be seen that the present description describes a system which can automatically detect when automated material transfer control is to be performed. In response to that detection, the present system can automatically control the propulsion and steering systems of a material transfer vehicle in order to move that vehicle into position relative to a haulage vehicle to perform an automated material transfer operation. The present system can also generate control signals to control the material conveyance subsystems to transfer material automatically, to execute a desired material transfer strategy, and to perform other control operations until the material transfer operation is complete, at which point the control of the material transfer vehicle can continue on an automated basis or under manual control to return to a harvester or to return to a different position, or the control of the material transfer vehicle can be controlled in other ways as well.

The present discussion has mentioned processors and servers. In one example, the processors and servers include computer processors with associated memory and timing circuitry, not separately shown. The processors and servers are functional parts of the systems or devices to which they belong and are activated by, and facilitate the functionality of the other components or items in those systems.

Also, a number of user interface (UI) displays have been discussed. The UI displays can take a wide variety of different forms and can have a wide variety of different user actuatable input mechanisms disposed thereon. For instance, the user actuatable input mechanisms can be text boxes, check boxes, icons, links, drop-down menus, search boxes, etc. The mechanisms can also be actuated in a wide variety of different ways. For instance, the mechanisms can be actuated using a point and click device (such as a track ball or mouse). The mechanisms can be actuated using hardware buttons, switches, a joystick or keyboard, thumb switches or thumb pads, etc. The mechanisms can also be actuated using a virtual keyboard or other virtual actuators. In addition, where the screen on which the mechanisms are displayed is a touch sensitive screen, the mechanisms can be actuated using touch gestures. Also, where the device that displays them has speech recognition components, the mechanisms can be actuated using speech commands.

A number of data stores have also been discussed. It will be noted the data stores can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

It will be noted that the above discussion has described a variety of different systems, subsystems, components, sensors and/or logic. It will be appreciated that such systems, subsystems, components, sensors and/or logic can be comprised of hardware items (such as processors and associated memory, or other processing components, some of which are described below) that perform the functions associated with those systems, subsystems, components, sensors and/or logic. In addition, the systems, subsystems, components, sensors and/or logic can be comprised of software that is loaded into a memory and is subsequently executed by a processor or server, or other computing component, as described below. The systems, subsystems, components, sensors and/or logic can also be comprised of different combinations of hardware, software, firmware, etc., some examples of which are described below. These are only some examples of different structures that can be used to form the systems, subsystems, components, sensors and/or logic described above. Other structures can be used as well.

It will also be noted that the information on map 107 can be output to the cloud.

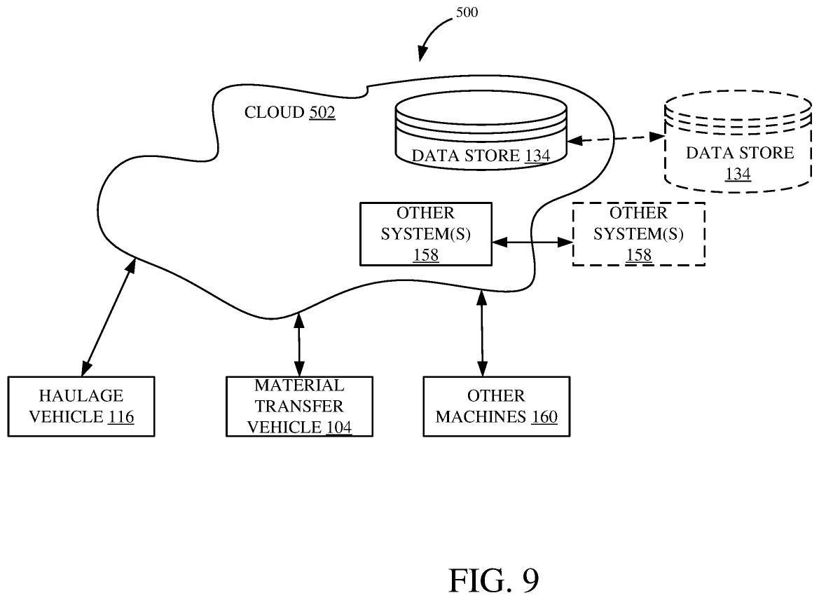

FIG. 9 is a block diagram of system 100, shown in FIG. 1, except that it is deployed in a remote server architecture 500. In an example, remote server architecture 500 can provide computation, software, data access, and storage services that do not require end-user knowledge of the physical location or configuration of the system that delivers the services. In various examples, remote servers can deliver the services over a wide area network, such as the internet, using appropriate protocols. For instance, remote servers can deliver applications over a wide area network and they can be accessed through a web browser or any other computing component. Software or components shown in previous FIGS. as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, they components and functions can be provided from a conventional server, or they can be installed on client devices directly, or in other ways.

In the example shown in FIG. 9, some items are similar to those shown in previous FIGS. and they are similarly numbered. FIG. 9 specifically shows that other systems 158 and data store 134 can be located at a remote server location 502. Therefore, items in system 100 access those systems through remote server location 502.

FIG. 9 also depicts another example of a remote server architecture. FIG. 9 shows that it is also contemplated that some elements of previous FIGS are disposed at remote server location 502 while others are not. By way of example, data store 134 can be disposed at a location separate from location 502, and accessed through the remote server at location 502. Regardless of where the items are located, the items can be accessed directly by machines 104, 116, 102, through a network (either a wide area network or a local area network), the items can be hosted at a remote site by a service, or the items can be provided as a service, or accessed by a connection service that resides in a remote location. Also, the data can be stored in substantially any location and intermittently accessed by, or forwarded to, interested parties. For instance, physical carriers can be used instead of, or in addition to, electromagnetic wave carriers. In such an example, where cell coverage is poor or nonexistent, another mobile machine (such as a fuel truck) can have an automated information collection system. As the machine comes close to the fuel truck for fueling, the system automatically collects the information from the machine using any type of ad-hoc wireless connection. The collected information can then be forwarded to the main network as the fuel truck reaches a location where there is cellular coverage (or other wireless coverage). For instance, the fuel truck may enter a covered location when traveling to fuel other machines or when at a main fuel storage location. All of these architectures are contemplated herein. Further, the information can be stored on the harvester until the harvester enters a covered location. The harvester, itself, can then send the information to the main network.

It will also be noted that the elements of previous FIGS., or portions of them, can be disposed on a wide variety of different devices. Some of those devices include servers, desktop computers, laptop computers, tablet computers, or other mobile devices, such as palm top computers, cell phones, smart phones, multimedia players, personal digital assistants, etc.

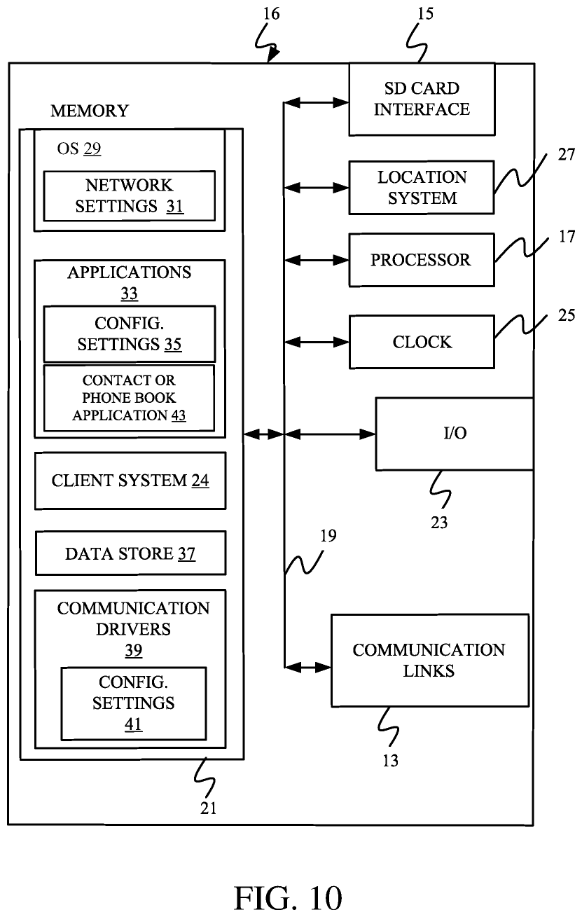

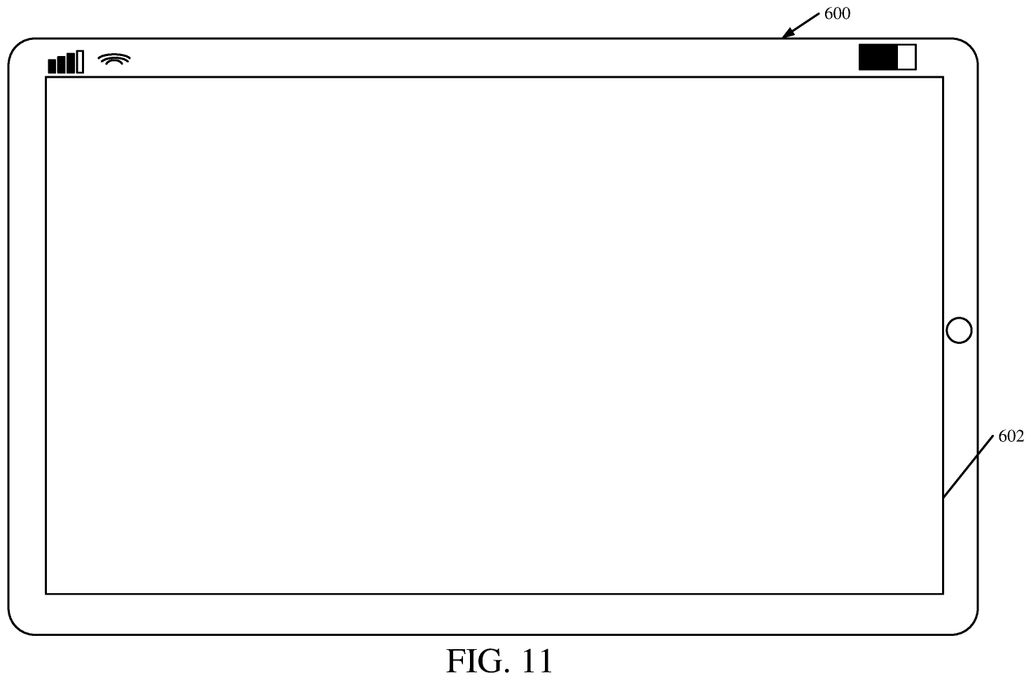

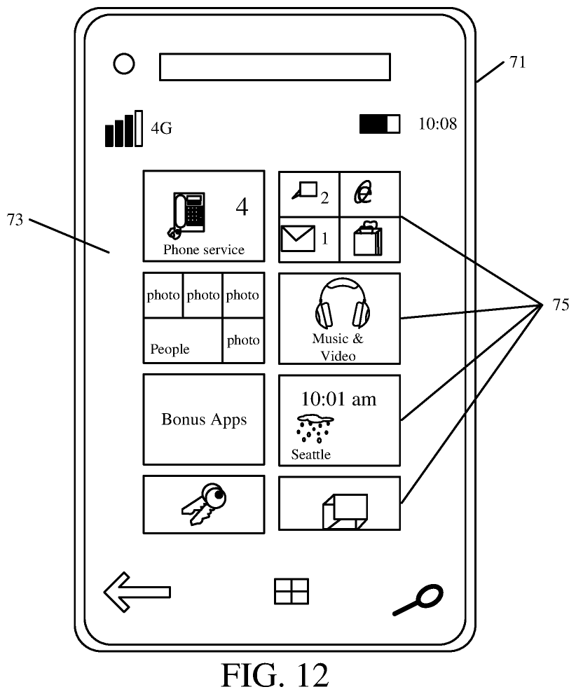

FIG. 10 is a simplified block diagram of one illustrative example of a handheld or mobile computing device that can be used as a user's or client's hand held device 16, in which the present system (or parts of it) can be deployed. For instance, a mobile device can be deployed in the operator compartment of material transfer vehicle 104 for use in generating, processing, or displaying the position and control data. FIGS. 11-12 are examples of handheld or mobile devices.

FIG. 10 provides a general block diagram of the components of a client device 16 that can run some components shown in previous FIGS., that interacts with them, or both. In the device 16, a communications link 13 is provided that allows the handheld device to communicate with other computing devices and under some examples provides a channel for receiving information automatically, such as by scanning. Examples of communications link 13 include allowing communication though one or more communication protocols, such as wireless services used to provide cellular access to a network, as well as protocols that provide local wireless connections to networks.

In other examples, applications can be received on a removable Secure Digital (SD) card that is connected to an interface 15. Interface 15 and communication links 13 communicate with a processor 17 (which can also embody processors or servers from previous FIGS.) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, optical sensors, microphones, touch screens, proximity sensors, accelerometers, orientation sensors and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. Location system 27 can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. Memory 21 can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

FIG. 11 shows one example in which device 16 is a tablet computer 600. In FIG. 11, computer 600 is shown with user interface display screen 602. Screen 602 can be a touch screen or a pen-enabled interface that receives inputs from a pen or stylus. Computer 600 can also use an on-screen virtual keyboard. Of course, computer 600 might also be attached to a keyboard or other user input device through a suitable attachment mechanism, such as a wireless link or USB port, for instance. Computer 600 can also illustratively receive voice inputs as well.

FIG. 12 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

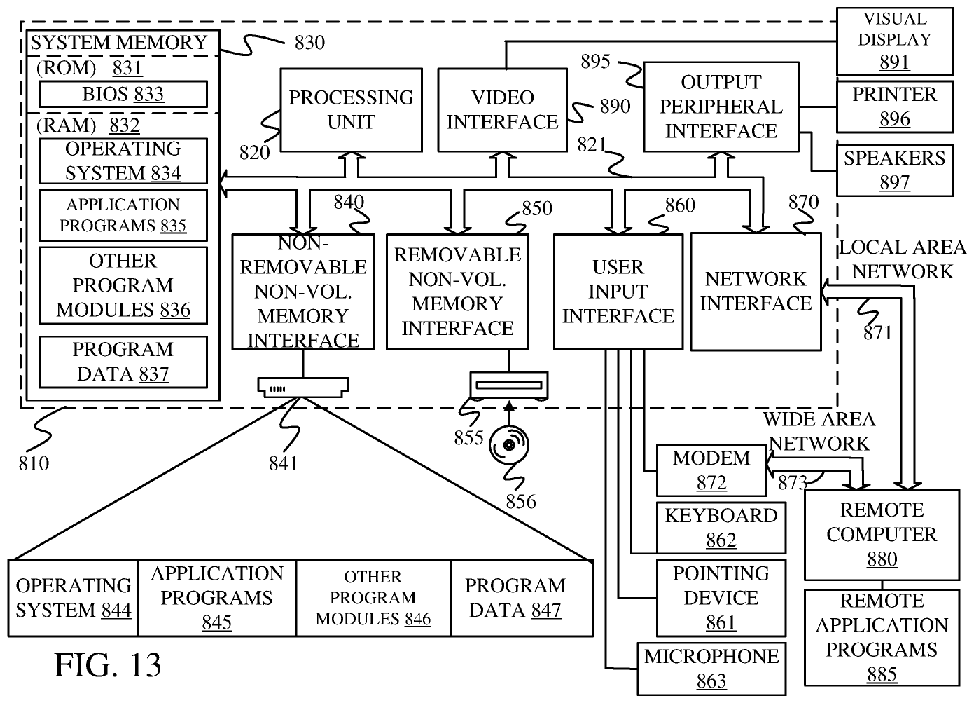

FIG. 13 is one example of a computing environment in which elements of previous FIGS., or parts of it, (for example) can be deployed. With reference to FIG. 13, an example system for implementing some embodiments includes a computing device in the form of a computer 810 programmed to operate as described above. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. Memory and programs described with respect to previous FIGS. can be deployed in corresponding portions of FIG. 13.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. Computer storage media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 13 illustrates operating system 834, application programs 835, other program modules 836, and program data 837.

The computer 810 may also include other removable/non-removable volatile/nonvolatile computer storage media. By way of example only, FIG. 13 illustrates a hard disk drive 841 that reads from or writes to non-removable, nonvolatile magnetic media, an optical disk drive 855, and nonvolatile optical disk 856. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 13, provide storage of computer readable instructions, data structures, program modules and other data for the computer 810. In FIG. 13, for example, hard disk drive 841 is illustrated as storing operating system 844, application programs 845, other program modules 846, and program data 847. Note that these components can either be the same as or different from operating system 834, application programs 835, other program modules 836, and program data 837.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures. A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections (such as a controller area network-CAN, local area network-LAN, or wide area network WAN) to one or more remote computers, such as a remote computer 880.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. In a networked environment, program modules may be stored in a remote memory storage device. FIG. 13 illustrates, for example, that remote application programs 885 can reside on remote computer 880.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A material transfer vehicle, comprising:
a propulsion subsystem configured to provide propulsion to the material transfer vehicle;
a steering subsystem configured to control a heading of the material transfer vehicle;
a material transfer subsystem configured to transfer material from the material transfer vehicle through an outlet end of an unloading spout to a landing point;
a sensor configured to detect a haulage vehicle and generate a sensor signal;
a localization processor configured to identify a location of the haulage vehicle relative to a location of the material transfer vehicle;
a fill level detection system configured to detect a fill level of material in the haulage vehicle based on the sensor signal;
a transfer strategy execution system configured to generate a transfer control signal based on the location of the haulage vehicle relative to the material transfer vehicle, based on the detected fill level, and based on a transfer strategy; and
a control signal generator configured to generate control signals to control the propulsion subsystem, the steering subsystem, and the material transfer subsystem to automatically position the material transfer vehicle in an unloading position relative to the haulage vehicle and transfer material to the haulage vehicle according to the transfer strategy, based on the transfer control signal.

2. The material transfer vehicle of claim 1 and further comprising:
a trigger detection system configured to detect a trigger criterion to begin automated transfer control, the transfer strategy execution system generating the transfer control signal responsive to the detected trigger criterion.

3. The material transfer vehicle of claim 2 and further comprising:
a vicinity processor configured to detect whether the haulage vehicle is within a threshold distance of the material transfer vehicle and if so output, as the trigger criterion, a vehicle proximity signal.

4. The material transfer vehicle of claim 1 wherein the localization processor is configured to detect a location and orientation of the sensor and to identify the location of the haulage vehicle relative to the material transfer vehicle based on the location and orientation of the sensor.

5. The material transfer vehicle of claim 4 wherein the sensor comprises an image capture device and further comprising:
an image processor configured to identify a haulage vehicle parameter in the captured image.

6. The material transfer vehicle of claim 5 wherein the localization processor is configured to locate the haulage vehicle parameter identified in the captured image relative to the image capture device.

7. The material transfer vehicle of claim 6 wherein the localization processor is configured to access dimension information indicative of a location of the unloading spout on the material transfer vehicle and locate the haulage vehicle parameter relative to the unloading spout based on the dimension information.

8. The material transfer vehicle of claim 7 and further comprising:
a sensor processing system configured to identify, as the haulage vehicle parameter, an edge of a receiving area of the haulage vehicle, based on the sensor signal.

9. The material transfer vehicle of claim 8 wherein the control signal generator is configured to generate control signals to control the propulsion subsystem and the steering subsystem to automatically move the material transfer vehicle from the unloading position to a plurality of successive unloading positions relative to the haulage vehicle based on the fill level, to execute the transfer strategy.

10. A method, comprising:
detecting a haulage vehicle with a sensor on a material transfer vehicle that has a propulsion subsystem configured to provide propulsion to the material transfer vehicle, a steering subsystem configured to control a heading of the material transfer vehicle, and a material transfer subsystem configured to transfer material from the material transfer vehicle through an outlet end of an unloading spout to a landing point;
generating a sensor signal indicative of the detected haulage vehicle;
identifying a location of the haulage vehicle relative to a location of the material transfer vehicle based on the sensor signal;
detecting a fill level of material in the haulage vehicle based on the sensor signal;
generating a transfer control signal based on the location of the haulage vehicle relative to the material transfer vehicle, based on the detected fill level, and based on a transfer strategy; and
generating control signals to control the propulsion subsystem, the steering subsystem, and the material transfer subsystem to automatically position the material transfer vehicle in an unloading position relative to the haulage vehicle and transfer material to the haulage vehicle according to the transfer strategy, based on the transfer control signal.

11. The method of claim 10 wherein generating a transfer control signal comprises:
detecting a trigger criterion to begin automated transfer control; and
generating the transfer control signal responsive to the detected trigger criterion.

12. The method of claim 11 and further comprising:
detecting whether the haulage vehicle is within a threshold distance of the material transfer vehicle; and
if so, outputting, as the trigger criterion, a vehicle proximity signal.

13. The method of claim 10 wherein identifying a location of the haulage vehicle relative to a location of the material transfer vehicle comprises:
detecting a location and orientation of the sensor; and
identifying the location of the haulage vehicle relative to the material transfer vehicle based on the location and orientation of the sensor.

14. The method of claim 13 wherein generating a sensor signal comprises:
capturing, with an image capture device, an image of the haulage vehicle; and
identifying a haulage vehicle parameter in the captured image.

15. The method of claim 14 wherein identifying a haulage vehicle parameter comprises:
identifying the location of the haulage vehicle parameter identified in the captured image relative to the image capture device.

16. The method of claim 15 wherein identifying a location of the haulage vehicle relative to a location of the material transfer vehicle comprises:
accessing dimension information indicative of a location of the unloading spout on the material transfer vehicle; and
locating the haulage vehicle parameter relative to the unloading spout based on the dimension information.

17. The method of claim 14 wherein identifying a haulage vehicle parameter comprises:
identifying, as the haulage vehicle parameter, an edge of a receiving area of the haulage vehicle, based on the sensor signal.

18. The method of claim 17 wherein generating control signals comprises:
generating control signals to control the propulsion subsystem and the steering subsystem to automatically move the material transfer vehicle from the unloading position to a plurality of successive unloading positions relative to the haulage vehicle based on the fill level, to execute the transfer strategy.

19. A control system, comprising:
a sensor configured to detect a characteristic of a haulage vehicle and generate a sensor signal indicative of the detected characteristic, the sensor being mounted on a material transfer vehicle that has a propulsion subsystem configured to provide propulsion to the material transfer vehicle, a steering subsystem configured to control a heading of the material transfer vehicle, and a material transfer subsystem configured to transfer material from the material transfer vehicle through an outlet end of an unloading spout to a landing point;
at least one processor; and
memory storing computer executable instructions which, when executed by the at least one processor, cause the at least one processor to perform steps, comprising:
identifying a location of a receiving area in the haulage vehicle relative to a location of the material transfer vehicle based on the sensor signal;
detecting a fill level of material in the haulage vehicle based on the sensor signal;
generating a transfer control signal based on the location of the receiving area of the haulage vehicle relative to the material transfer vehicle, based on the detected fill level, and based on a transfer strategy; and
generating control signals to control the propulsion subsystem, the steering subsystem, and the material transfer subsystem to automatically position the material transfer vehicle in an unloading position relative to the haulage vehicle and transfer material to the haulage vehicle according to the transfer strategy, based on the transfer control signal.

20. The control system of claim 19 wherein identifying a location of a receiving area in the haulage vehicle relative to a location of the material transfer vehicle based on the sensor signal comprises identifying an edge of the receiving area of the haulage vehicle, based on the sensor signal, and wherein generating control signals comprises:
generating control signals to control the propulsion subsystem and the steering subsystem to automatically move the material transfer vehicle from the unloading position to a plurality of successive unloading positions relative to the haulage vehicle based on the fill level, to execute the transfer strategy.
